(19) United States
(12) Patent Application Publication
(10) Pub. No.: US 2021/0341326 A1
(43) Pub. Date: Nov. 4, 2021

(54) MEASURING TRANSDUCER AND MEASURING DEVICE

(71) Applicant: Endress+Hauser Flowtec AG, Reinach (CH)

(72) Inventors: Severin Ramseyer, Münchenstein (CH); Benjamin Schwenter, Breitenbach (CH); Marc Werner, Grenzach-Wyhlen (DE); Claude Hollinger, Aesch (CH); Martin Stucki, Pratteln (CH)

(21) Appl. No.: 17/268,764

(22) PCT Filed: Jul. 30, 2019
(86) PCT No.: PCT/EP2019/070469

§ 371 Date: Feb. 16, 2021

(30) Foreign Application Priority Data
Aug. 16, 2018 (DE) 10 2018 119 941.4

(51) Int. Cl. G01F 1/84; G01N 9/00

(52) U.S. Cl. CPC G01F 1/8413; G01F 1/8427; G01F 1/8422; G01N 9/002

(57) ABSTRACT

The disclosure relates to a measuring transducer of a measuring device for registering a mass flow or a density of a medium flowing through a measuring tube of the measuring transducer. An exciter excites the measuring tube to execute oscillations. At least two sensors are adapted to register deflections of oscillations of the measuring tube. At least one exciter and the sensors each have a coil apparatus with, in each case, at least one coil, as well as, in each case, a magnet apparatus, wherein the magnet apparatuses are movable relative to their coil apparatuses. The magnet apparatus of a sensor or exciter has, in each case, at least one magnet, wherein the measuring transducer has a support body, which is adapted to hold the at least one measuring tube. The coil apparatuses of the sensors or the coil apparatus of the exciter are secured separately on the support body.

The invention relates to a measuring transducer of a measuring device for registering a mass flow or a density of a medium flowing through at least one measuring tube of the measuring transducer, wherein the measuring of the mass flow, or density, of the medium is based on evaluation of measuring tube oscillations impressed on the measuring tube. The invention relates as well as to such a measuring device.

Measuring transducers, and measuring devices, which determine a mass flow, or a density, based on evaluated measuring tube oscillations, are well known. Thus, DE102015120087 describes a measuring device having two oppositely oscillating measuring tubes, wherein sensors for registering measuring tube oscillations comprise a magnet as well as a coil apparatus, wherein magnet and associated coil apparatus are secured to different measuring tubes. Disadvantageous in this solution is that the measuring tubes carry different masses and, because of this, have different oscillatory behaviors.

A further example of a measuring transducer, and measuring device, is provided by U.S. Pat. No. 5,349,872B, wherein a sensor coil carrier with three sensor coil pairs reaches around a measuring tube pair, wherein the sensor coils of each sensor coil pair are arranged on oppositely lying measuring tube sides. The measuring tubes carry a number of magnets, which are adapted to follow measuring tube oscillatory movements and to induce electrical voltages in the sensor coils. The sensor coil carrier is mounted by means of securements on a measuring tube housing. Disadvantageous in this solution is that it is difficult to avoid housing oscillations and, because of this, not only measuring tube oscillations but also housing oscillations contribute to sensor coil signals.

An object of the invention is, consequently, a measuring transducer as well as a measuring device, wherein undesired influences on a sensor system are largely minimized.

The object is achieved by a measuring transducer as defined in independent claim 1 as well as by a measuring device as defined in independent claim 15.

A measuring transducer of the invention for a measuring device for registering a mass flow or a density of a medium flowing through at least one measuring tube of the measuring transducer includes:

the at least one measuring tube having an inlet and an outlet and adapted to convey the medium between inlet and outlet;

at least one exciter, which is adapted to excite the at least one measuring tube to execute oscillations;

at least two sensors, which are adapted to register deflections of oscillations of at least one measuring tube;

wherein at least one exciter as well as the sensors each have a coil apparatus with, in each case, at least one coil, as well as, in each case, a magnet apparatus, wherein the magnet apparatuses are movable relative to their coil apparatuses,

wherein the magnet apparatus of a sensor or exciter has, in each case, at least one magnet, wherein the magnet is secured to a measuring tube,

wherein the coils of the sensor or exciter have in a cross section, in each case, a winding region and a central region without windings, and

wherein the magnet apparatus and the coil apparatus of an exciter, or sensor, as the case may be, interact by means of magnetic fields,

wherein the measuring transducer has a support body, which is adapted to hold the at least one measuring tube,

wherein the coil apparatuses of the sensors and/or the coil apparatus of the exciter are/is secured separately on the support body,

wherein the support body has at least one first eigenfrequency, and wherein the at least one measuring tube has at least one second eigenfrequency, wherein the exciter is adapted to operate the measuring tube in the region of at least one second eigenfrequency, wherein the at least one first eigenfrequency is pairwise different from the at least one excited second eigenfrequency,

wherein an amplitude peak of the support body in the region of the at least one excited second eigenfrequency of the measuring tube is less by a factor F than an amplitude peak of the at least one measuring tube,

wherein F is at least 1000, and especially at least 5000, and preferably at least 10000.

In this way, the coils are decoupled from the measuring tube as well as from an environment of the measuring transducer, so that in very good approximation exclusively measuring tube oscillations contribute to the induction of electrical voltages in the coils.

In an embodiment, the coil apparatuses are arranged on a measuring tube side facing the support body.

Then the measuring tube can be simply removed, or reinstalled, without needing to move the coil apparatuses.

In an embodiment, the at least one measuring tube is releasably secured to the support body by means of a measuring tube holder, wherein the measuring tube holder has a coupling,

wherein the at least one measuring tube is decoupleable by means of a movement away from the support body.

In an embodiment, a measuring tube oscillatory deflection has an oscillation direction, and wherein the coil has a longitudinal axis,

wherein a scalar product of a vector in parallel with the oscillation direction and a vector in parallel with the longitudinal axis is zero.

In an embodiment, the central region has a rectangular shape with a first side and a second side, wherein the first side has a first side length, and wherein the second side has a second side length, wherein a ratio of first side length to second side length is greater than 3.25 and especially greater than 3.5 and preferably greater than 3.75, wherein the rectangular shape of the central region has a first side bisector belonging to the first side as well as a second side bisector belonging to the second side,

wherein the magnet apparatus of a sensor or exciter has on at least one measuring tube at least one magnet having at least one magnet end surface facing toward the coil apparatus, wherein the magnet end surface is bounded by two first magnet edges arranged opposite one another and two second magnet edges arranged opposite one another,

wherein, in the case of a measuring tube in rest position and considering the magnet end surface in a projection onto a coil cross-section, the second magnet edges extend in the direction of an oscillation direction of the measuring tube in parallel with the second side into the central region, wherein a first magnet edge facing the second side bisector is spaced a distance from the second side bisector, wherein the measuring tube is adapted to oscillate with an oscillation amplitude, wherein the distance is greater than half the oscillation amplitude,

wherein the first magnet edge facing the second side bisector extends especially in parallel with the second side bisector.

By providing a rectangular shape with a long side and a short side, a movement of a magnet in the direction of the short side can be registered and measured very precisely, especially when the magnet has in the direction of the first side an extent in the range of the length of the first side.

Then even a small movement of the magnet compared with conventional coil apparatuses is sufficient to provide a noticeable change of a magnetic flux through the coil and, because of this, induction of an electrical voltage in the coil.

In an embodiment, the first side length is at least 3 millimeter and especially at least 4 millimeter and preferably at least 5 millimeter and/or the first side length is at most 20 millimeter and especially, at most, 15 millimeter and preferably, at most, 12 millimeter, and/or

wherein the second side length is at least 0.3 millimeter and especially at least 0.5 millimeter and preferably at least 1 millimeter and/or, at most, 5 millimeter and especially, at most, 4 millimeter and preferably, at most, 3 millimeter.

In an embodiment, the magnet end surface is rectangular.

In an embodiment, the second magnet edge in the case of a measuring tube in rest position overlaps the winding region completely in the direction of the second magnet edge.

In an embodiment, a length of the first magnet edge is at least 5% and especially at least 10% and preferably at least 20% less than the first side length, or

wherein a length of the first magnet edge is at least 50 micrometer and especially at least 75 micrometer and preferably at least 100 micrometer less than the first side length, and

wherein the first magnet edge facing the second side bisector in the projection is spaced from the winding region in a direction in parallel with the second side bisector.

In an embodiment, the magnet end surface is perpendicular to a coil axis and has from the coil apparatus a spacing of at least 20 micrometer and especially at least 40 micrometer and preferably at least 50 micrometer, and/or

wherein the magnet end surface has from the coil apparatus a spacing of, at most, 200 micrometer and especially, at most, 150 micrometer and preferably, at most, 120 micrometer.

In an embodiment, the magnet of a magnet apparatus has a horseshoe shape with a closed end and an open end, wherein the open end is adapted to surround an associated coil apparatus and to supply the coil apparatus with a magnetic field extending in parallel with a coil axis,

wherein the at least one measuring tube has a cross sectional plane, which divides the measuring tube into an inlet side and an outlet side, wherein the inlet side as well as the outlet side are mirror symmetrical about the cross sectional plane, wherein the coil axes of the coil apparatuses are perpendicular to the cross sectional plane.

In this way, a removability of the measuring tube in the case of horseshoe shaped magnet is assured.

In an embodiment, the measuring transducer comprises at least one pair of measuring tubes, wherein the measuring tubes of the pair are adapted to oscillate oppositely from one another,

wherein at least one sensor and/or at least one exciter each have/has a coil apparatus with a coil as well as a magnet apparatus having at least two magnets,

wherein at least one magnet is arranged on each measuring tube of the measuring tube pair.

In an embodiment, the coil apparatus comprises a circuit board with a plurality of circuit board layers, wherein a plurality of circuit board layers have, in each case, a coil with, in each case, a first coil end and, in each case, a second coil end,

wherein the coils are interconnected galvanically serially and/or in parallel with one another,

wherein the coils of different circuit board layers produce upon applying an electrical voltage constructively interfering magnetic fields,

wherein the coils have, in each case, a plurality of coil windings.

A galvanically parallel connecting of the coils can mean a serial connecting of the inductances of the coils. Relevant for the type of connecting of inductances is a spatial arrangement of the inductances relative to one another.

In an embodiment, the at least one coil has, in each case, at least 4, and especially at least 5 and preferably at least 6 windings, and/or

wherein a total number of windings of the at least one coil is at least 65, and especially at least 70 and preferably at least 72.

In an embodiment, the measuring transducer includes two manifolds, wherein a first manifold is adapted in an upstream directed side of the measuring transducer to receive a medium inflowing from a pipeline into the measuring transducer and to convey such to the inlet of the at least one measuring tube,

wherein a second manifold is adapted to receive medium draining from the at least one measuring tube and to convey such back into the pipeline.

In an embodiment, the measuring transducer includes two process connections, especially flanges, which are adapted to connect the measuring transducer into a pipeline.

A measuring device of the invention comprises:

a measuring transducer of the invention;

an electronic measuring/operating circuit, wherein the electronic measuring/operating circuit is adapted to operate the sensors and the exciter, and is connected with these by means of electrical connections,

wherein the at least one electrical connection is led by means of a cable guide to the electronic measuring/operating circuit,

wherein the electronic measuring/operating circuit is further adapted to ascertain flow measured values and/or density measured values and,

wherein the measuring device has especially an electronics housing for housing the electronic measuring/operating circuit.

The invention will now be described based on examples of embodiments illustrated in the appended drawing, the figures of which show as follows:

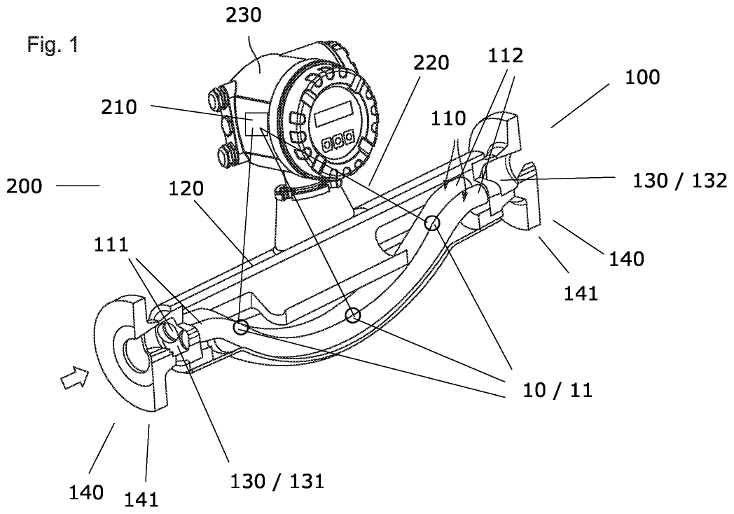

FIG. 1 a measuring device of the invention having a measuring transducer of the invention.

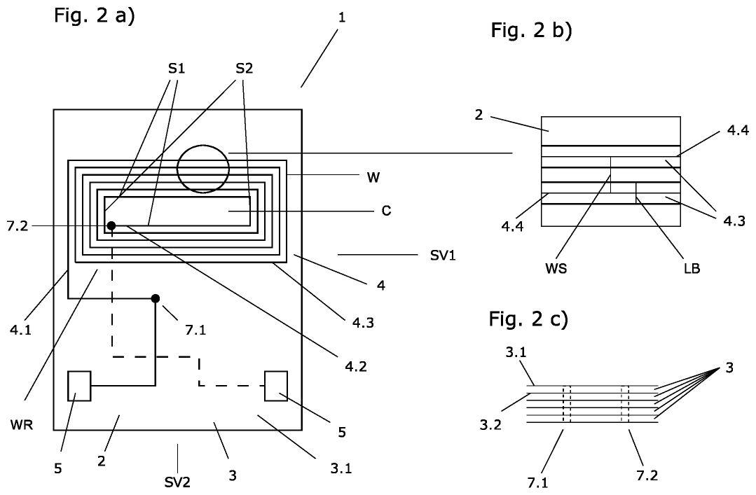

FIGS. 2a) to c) schematically, a coil apparatus of the invention.

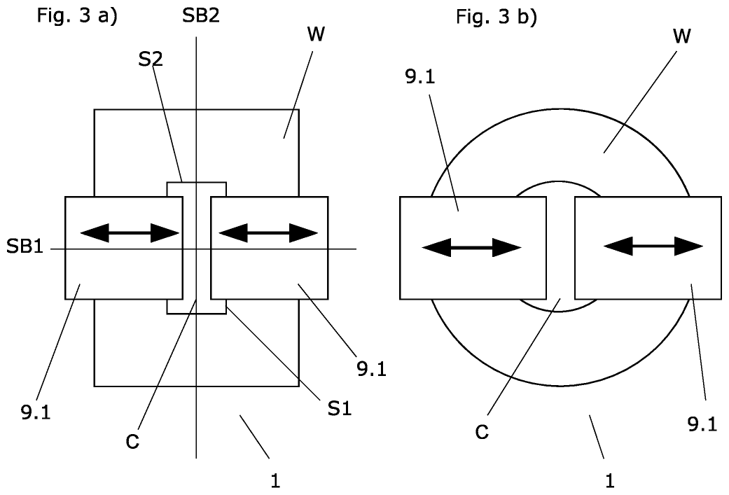

FIGS. 3a) and b) schematically, a comparison of a coil apparatus of the invention and a coil apparatus of the state of the art.

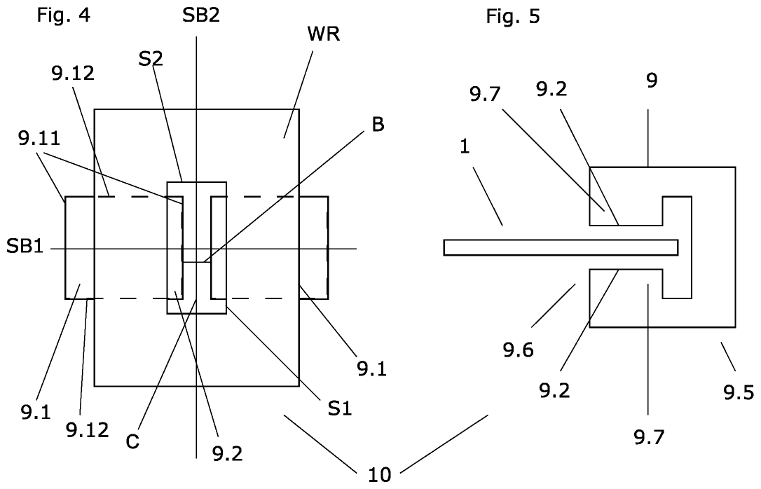

FIGS. 4 and 5 schematically by way of example, embodiments of sensors of the invention.

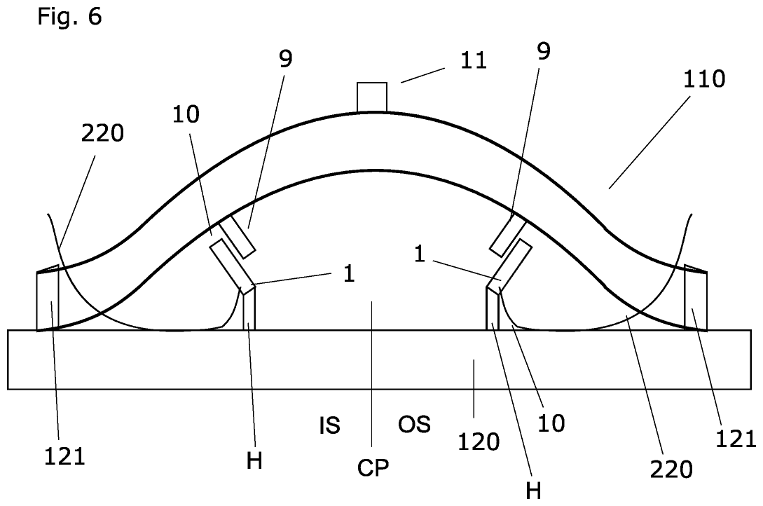

FIG. 6 by way of example, arrangements of coil apparatuses and magnet apparatuses for two measuring tubes.

FIG. 1 shows a measuring device 200 having a measuring transducer 100, wherein the measuring transducer has two measuring tubes 110, which are held by a support body 120 of the measuring transducer. The measuring tubes communicate on the inlet side with a first manifold 131 and on the outlet side with a second manifold 132, wherein the first manifold 131 of the manifolds 130 is its adapted to receive a medium inflowing from a pipeline (not shown) into the measuring transducer and to distribute such uniformly to the measuring tubes. Correspondingly, the second manifold 132 is adapted to receive medium draining from the measuring tubes and to transfer such back into the pipeline. The measuring transducer is, in such case, inserted via process connections 140, especially flanges 141, into the pipeline. The measuring transducer includes an oscillation exciter 11, which is adapted to excite the measuring tubes to oscillate. The measuring transducer includes, supplementally, two oscillation sensors 10, which are adapted to register the oscillations of the measuring tubes. Those skilled in the art are not limited to the numbers of measuring tubes, oscillation exciters and oscillation sensors shown here. The embodiment shown here is thus by way of example.

The measuring device includes an electronic measuring/operating circuit 210, which is adapted to operate the oscillation exciter as well as the oscillation sensors, and to calculate and to output mass flow- and/or density measured values of the medium. The electronic measuring/operating circuit is, in such case, connected by means of electrical connections 220 with the oscillation sensors as well as with the oscillation exciter. The measuring device includes an electronics housing 230, in which the electronic measuring/operating circuit is arranged. For determining the mass flow, the measuring device utilizes the Coriolis effect of the medium flowing through the measuring tubes, in the case of which the flow influences the measuring tube oscillations characteristically.

FIG. 2a) shows a plan view of an advantageous coil apparatus 1 of the invention with a circuit board 2, which has a plurality of circuit board layers 3 with, in each case, a first face 3.1 and a second face 3.2. A coil 4 having a first coil end 4.1 and a second coil end 4.2 is applied in the form of an electrically conductive trace 4.3 such as shown here on a first face 3.1. Other circuit board layers can have other coils, which are connected together, for example, with vias 7, wherein, for example, a first via 7.1 connects first coil ends, and wherein a second via 7.2 connects second coil ends together, which would correspond to a connecting of coils in parallel. Alternatively, instead of the galvanic, parallel connecting of the coils, also a galvanic, serial connecting can occur, wherein coil ends of neighboring coils are connected, for example, by means of vias, and wherein adjoining coils, in each case, have an oppositely moving rotational sense of their electrically conductive traces. Important is that the coils of different circuit board layers produce constructively interfering magnetic fields upon the application of an electrical, direct voltage between the vias. Alternatively, instead of the here described galvanic, parallel connecting of the coils, also a galvanic, serial connecting can be used, wherein coil ends of neighboring coils are connected, for example, by means of vias, and wherein adjoining coils have, in each case, an oppositely moving rotational sense of their electrically conductive traces. Those skilled in the art can design coil apparatuses according to their particular requirements. A coil apparatus includes contacting elements 5, by means of which the coil apparatus is connectable by means of electrical connecting lines 220 (see FIGS. 1 and 6) with an electronic measuring/operating circuit 210 (see FIG. 1) of a measuring device.

Coil 4 includes a winding region WR and a central region C without windings, wherein the central region has a rectangular shape with two opposing, first sides S1 and two opposing, second sides S2. The first sides S1 have a first side length, and the second sides have a second side length, wherein a ratio of first side length to second side length is greater than 2, and especially greater than 3 and preferably greater than 3.5.

The first side length is, for example, at least 3 millimeter and especially at least 4 millimeter and preferably at least 5 millimeter and/or at most 20 millimeter and especially, at most, 15 millimeter and preferably, at most, 12 millimeter, while the second side length is, for example, at least 0.3 millimeter and especially at least 0.5 millimeter and preferably at least 1 millimeter and/or, at most, 5 millimeter and especially, at most, 4 millimeter and preferably, at most, 3 millimeter. Larger geometric coil dimensions improve signal/noise ratio, when a magnet applied for induction of electric fields in the coil has similar dimensions as regards the first side. A magnet must not, however, be too heavy, since otherwise it can influence measuring tube oscillations to an undesirable degree. One skilled in the art with experience in the construction of measuring transducers, or measuring devices, of the type used for the invention can estimate maximum geometric dimensions of such a magnet and therefrom derive upper limits for the first side, and second side, of the coil.

A coil of the invention has, in such case, at least 4 windings and preferably at least, such as shown here, 6 windings.

FIG. 2b) shows an enlarged detail of the winding region WR with two sections of neighboring windings W. Focusing on a trace centerline 4.4, the windings have a winding separation WS, which is less by a factor F than two times the trace breadth, wherein F is at least 1, and especially at least 1.2 and preferably at least 1.4. The trace breadth TB is, in such case, less than 500 micrometer, and preferably less than 400 micrometer and especially less than 300 micrometer.

As shown in FIG. 2c), a circuit board 3 can have a plurality of circuit board layers, wherein a plurality of circuit board layers have, in each case, a coil. The coils of a plurality of circuit board layers are, in such case, connected by vias 7.1, 7.2, such that the coils of different circuit board layers produce constructively interfering magnetic fields upon the application of an electrical voltage across the vias. For example, such as shown here, a first via 7.1 can connect first coil ends 4.1 and a second via 7.2 second coil ends 4.2 of different coils together. This corresponds to a parallel circuit of different coils. Alternatively, adjoining coils can be connected together via adjoining coil ends, wherein a first coil end of an outer coil is connected with a contacting element 5, and wherein a second coil end of an additional outer coil is connected with another contacting element, and wherein adjoining coil ends are connected by means of vias. This would correspond to a series connection of different coils.

Preferably, a coil apparatus has at least 6, and preferably at least 8 and especially at least 10 coils, which are stacked by means of circuit board layers. A circuit board layer forming substrate is, in such case, preferably thinner than 200 micrometer and preferably thinner than 150 micrometer. The substrate comprises, in such case, for example, the material, DuPont 951. The electrically conductive trace applied on the substrate comprises, in such case, for example, the material, DuPont 614SR.

Different coils have, in such case, an ohmic resistance of less than 50 ohm and especially less than 40 ohm and preferably less than 30 ohm, wherein differences of the ohmic resistances of different coils are less than 10 ohm, and especially less than 5 ohm and preferably less than 2 ohm.

FIGS. 3a) and b) show, by way of example, a comparison between a coil apparatus 1 of the invention, see FIG. 3 a), and a conventional coil arrangement 1, see FIG. 3b). Shown in both cases, by way of example, is a magnet apparatus 9 having two magnets 9.1, wherein each magnet 9.1 is secured on a different one of two measuring tubes (not shown), in order to follow the oppositely moving movements of the measuring tubes. The rectangular central region C of the coil apparatus of the invention has a first side S1 with a side length, which equals a diameter of the round central region C of the conventional coil arrangement. The area of the rectangular central region is, in such case, less than the area of the round central region. A measuring tube oscillation with given amplitude in the case of magnets of equal dimensions compared with the particular area of the central region in the case of the rectangular central region leads to a, relatively considered, greater change of a magnetic field passing through the coil apparatus. Thus, a density of a medium or a mass flow of a medium flowing through the measuring tube can be determined more exactly.

FIG. 4 shows schematically a plan view of a sensor having a coil apparatus and magnets 9.1 of a magnet apparatus 9 matched to the coil apparatus. Each magnet is secured to a different one of two measuring tubes (not shown) and the measuring tubes oscillate opposite to one another.

The magnets have, in each case, a magnet end surface 9.2 facing the coil apparatus and bordered by first magnet edges 9.11 and second magnet edges 9.12. The distance of a first magnet edge from the second side bisector SH2 of the second side of the central region amounts in the case of a measuring tube in resting position preferably to a minimum of 30 micrometer, and especially a minimum of 60 micrometer. The first magnet edge facing the second side bisector is, in such case, preferably in parallel with the second side bisector. The magnet end surface is, in such case, advantageously, however, not necessarily, rectangular. The magnets 9.1, in such case, overlap the winding region WR in the direction of their second magnet edges 9.12 preferably completely. The first magnet edges 9.11 have, in such case, a lesser length than the first sides S1 of the central region, wherein the magnets are preferably arranged essentially symmetrically about the first side bisector SH1.

Instead of two measuring tubes with, in each case, at least one magnet, which is associated with a sensor, a measuring transducer can also have only one measuring tube with at least one magnet, by means of which an electrical voltage is inducible in the coil apparatus.

FIG. 5 shows, by way of example, a side view of another coil apparatus, wherein the side view can be obtained by means of a rotation of 90 degree of the embodiment shown in FIG. 4 around the first side bisector. Instead of a magnet with a magnet end surface facing toward the coil apparatus, the magnet has a ring shape, so that two mutually facing side surfaces 9.2 facing an interposed coil apparatus supply the coil apparatus in a limited region with an approximately spatially homogeneous magnetic field supply, wherein the magnet surrounds the coil apparatus.

FIG. 6 shows a side view of a measuring tube 110 of a measuring transducer, or measuring device, having two oscillation sensors 10 comprising, in each case, a coil apparatus 1 of the invention from a side view SV2, see FIG. 2, wherein the coil apparatuses of the invention are mechanically connected with the support body 120 by means, in each case, of a holder H. The measuring transducer can, in such case, have, for example, two measuring tubes, which are adapted to oscillate oppositely to one another.

The support body has, in such case, at least one first eigenfrequency, while the at least one measuring tube has at least one second eigenfrequency, wherein the exciter is adapted to operate the measuring tube in the region of at least one second eigenfrequency, wherein the at least one first eigenfrequency is pairwise different from the at least one excited second eigenfrequency, wherein an amplitude peak of the support body in the region of the at least one excited second eigenfrequency of the measuring tube is less by a factor F than an amplitude peak of the at least one measuring tube, wherein F is at least 1000, and especially at least 5000, and preferably at least 10000. In this way, the coil apparatuses are decoupled as much as possible from the measuring tube, and, because of this, a high signal quality is achievable. The at least one second eigenfrequency can be located, for example, in a frequency range of 150 Hz to 900 Hz. In order to implement a factor F, it is advantageous that the at least one first eigenfrequency has a minimum separation of 10 Hz and especially at least 20 Hz and preferably at least 30 Hz from each second eigenfrequency.

A cross sectional plane CP divides the at least one measuring tube into the inlet side section IS and the outlet side section OS.

Since the coil apparatuses are secured on the support body, the electrical connections 220 can be led along the support body. In such case, the arrangement of contacting elements according to the invention enables equally long electrical connections and an equal leading of the electrical connections.

Alternatively, the measuring transducer can have, for example, only one measuring tube, wherein magnet apparatuses of sensors are secured to the measuring tube, and associated coil apparatuses are secured to the support body. The measuring transducer can also have more than two measuring tubes. Those skilled in the art can adapt coil apparatuses corresponding to requirements.

The at least one measuring tube can, such as shown here, have at least one bend or also extend in a straight line. The applicability the coil apparatus is independent of measuring tube geometry.

The at least one measuring tube is, in such case, secured to the support body by means of a securement apparatus 121 and can especially be removed from the support body, without that the coil apparatuses of the oscillation sensors must first be removed. In this regard, the magnet apparatuses can, such as shown here, be arranged, for example, on a side of the coil apparatuses 1 facing away from the support body.

List of Reference Characters

| | |
|---|---|
| 1 | coil apparatus |
| 2 | circuit board |
| 3 | circuit board layer |
| 3.1 | first face |
| 3.2 | second face |
| 4 | coil |
| 4.1 | first coil end |
| 4.2 | second coil end |
| 4.3 | electrically conductive trace |
| 4.4 | trace centerline |
| 5 | contact |
| 7 | via |
| 9 | magnet apparatus |
| 9.1 | magnet |
| 9.11 | first magnet edge |
| 9.12 | second magnet edge |
| 9.2 | magnet end surface |
| 9.5 | closed end |
| 9.6 | open end |
| 9.7 | protrusion |
| 10 | oscillation sensor |
| 11 | oscillation exciter |
| 100 | measuring transducer |
| 110 | measuring tube |
| 111 | inlet |
| 112 | outlet |
| 120 | support body |
| 121 | securement apparatus |
| 130 | manifold |
| 131 | first manifold |
| 132 | second manifold |
| 140 | process connection |
| 141 | flange |
| 200 | measuring device |
| 210 | electronic measuring/operating circuit |
| 220 | electrical connecting lines |
| 230 | electronics housing |
| LB | trace breadth |
| WR | winding region |
| H | holder |
| WS | winding separation |
| C | central region |
| S1 | first side |
| S2 | second side |
| SH1 | first side bisector |
| SH2 | second side bisector |
| CP | cross sectional plane |
| IS | inlet side |
| OS | outlet side |
| MSS | measuring tube side facing the support body |

1-15. (canceled)

16. A measuring transducer of a measuring device for registering a mass flow or a density of a medium flowing through at least one measuring tube of the measuring transducer, comprising:
the at least one measuring tube having an inlet and an outlet and adapted to convey the medium between inlet and outlet;
at least one exciter, which is adapted to excite the at least one measuring tube to execute oscillations;
at least two sensors, which are adapted to register deflections of oscillations of at least one measuring tube;
wherein at least one exciter as well as the sensors each have a coil apparatus with, in each case, at least one coil, as well as, in each case, a magnet apparatus, wherein the magnet apparatuses are movable relative to their coil apparatuses,
wherein the magnet apparatus of a sensor or exciter has, in each case, at least one magnet, wherein the magnet is secured to a measuring tube,
wherein the coils of the sensor or exciter have in a cross section, in each case, a winding region and a central region without windings, and
wherein the magnet apparatus and the coil apparatus of an exciter, or sensor, as the case may be, interact by means of magnetic fields,
wherein the measuring transducer has a support body, which is adapted to hold the at least one measuring tube,
wherein the coil apparatuses of the sensors or the coil apparatus of the exciter is secured separately on the support body,
wherein the support body has at least one first eigenfrequency, and wherein the at least one measuring tube has at least one second eigenfrequency, wherein the exciter is adapted to operate the measuring tube in the region of at least one second eigenfrequency, wherein the at least one first eigenfrequency is pairwise different from the at least one excited second eigenfrequency,
wherein an amplitude peak of the support body in the region of the at least one excited second eigenfrequency of the measuring tube is less by a factor F than an amplitude peak of the at least one measuring tube,
wherein F is at least 1000.

17. The measuring transducer of claim 16,
wherein the coil apparatuses are arranged on a measuring tube side facing the support body.

18. The measuring transducer of claim 17,
wherein the at least one measuring tube is releasably secured to the support body by means of a measuring tube holder, wherein the measuring tube holder has a securement apparatus,
wherein the securement apparatus includes a coupling, screwed connection or clamped connection.

19. The measuring transducer of claim 16,
wherein a measuring tube oscillatory deflection has an oscillation direction, and wherein the coil has a longitudinal axis,
wherein a scalar product of a vector in parallel with the oscillation direction and a vector in parallel with the longitudinal axis is zero.

20. The measuring transducer of claim 19,
wherein the central region has a rectangular shape with a first side and a second side,
wherein the first side has a first side length, and wherein the second side has a second side length,
wherein a ratio of first side length to second side length is greater than 3.25, wherein the rectangular shape of the central region has a first side bisector belonging to the first side as well as a second side bisector belonging to the second side,
wherein the magnet apparatus of a sensor or exciter has on at least one measuring tube at least one magnet having at least one magnet end surface facing toward the coil apparatus,
wherein the magnet end surface is bounded by two first magnet edges arranged opposite one another and two second magnet edges arranged opposite one another,
wherein, in the case of a measuring tube in rest position and the magnet end surface in a projection onto a coil cross-section, the second magnet edges extend in the direction of an oscillation direction of the measuring tube in parallel with the second side into the central region, wherein a first magnet edge facing the second side bisector is spaced a distance from the second side bisector, wherein the measuring tube is adapted to oscillate with an oscillation amplitude,
wherein the distance is greater than half the oscillation amplitude,
wherein the first magnet edge facing the second side bisector extends especially in parallel with the second side bisector.

21. The measuring transducer of claim 20,
wherein the magnet end surface is rectangular.

22. The measuring transducer of claim 20,
wherein the second magnet edge in the case of a measuring tube in rest position overlaps the winding region completely in the direction of the second magnet edge.

23. The measuring transducer of claim 20,
wherein a length of the first magnet edge is at least 5% less than the first side length, or
wherein a length of the first magnet edge is at least 50 micrometer less than the first side length, and
wherein the first magnet edge facing toward the second side bisector in the projection is spaced from the winding region in a direction in parallel with the second side bisector.

24. The measuring transducer of claim 20,
wherein the magnet end surface is perpendicular to a coil axis and has from the coil apparatus a spacing of at least 20 micrometer, or
wherein the magnet end surface has from the coil apparatus a spacing of 200 micrometer.

25. The measuring transducer of claim 16,
wherein the magnet of a magnet apparatus has a horseshoe shape with a closed end and an open end, wherein the open end is adapted to surround an associated coil apparatus and to supply the coil apparatus with a magnetic field extending in parallel with a coil axis,
wherein the at least one measuring tube has a cross sectional plane, which divides the measuring tube into an inlet side and an outlet side, wherein the inlet side as well as the outlet side are mirror symmetrical about the cross sectional plane, wherein the coil axes of the coil apparatuses are perpendicular to the cross sectional plane.

26. The measuring transducer of claim 16,
wherein the measuring transducer has at least one pair of measuring tubes, wherein the measuring tubes of the pair are adapted to oscillate oppositely from one another,
wherein at least one sensor or at least one exciter each have a coil apparatus with a coil as well as a magnet apparatus having at least two magnets,
wherein at least one magnet is arranged on each measuring tube of the measuring tube pair.

27. The measuring transducer of claim 16,
wherein the coil apparatus comprises a circuit board with a plurality of circuit board layers,
wherein a plurality of circuit board layers have, in each case, a coil with, in each case, a first coil end and, in each case, a second coil end,
wherein the coils are interconnected serially or in parallel with one another,
wherein the coils of different circuit board layers produce upon applying an electrical voltage constructively interfering magnetic fields,
wherein the coils have, in each case, a plurality of coil windings.

28. The measuring transducer of claim 16,
wherein the measuring transducer includes two manifolds, wherein a first manifold is adapted in an upstream directed side of the measuring transducer to receive a medium inflowing from a pipeline into the measuring transducer and to convey such to the inlet of the at least one measuring tube,
wherein a second manifold is adapted to receive medium draining from the of the at least one measuring tube and to convey such back into the pipeline.

29. The measuring transducer of claim 16,
wherein the measuring transducer includes two process connections adapted to connect the measuring transducer into a pipeline.

30. A measuring device comprising:
a measuring transducer of a measuring device for registering a mass flow or a density of a medium flowing through at least one measuring tube of the measuring transducer, comprising:
the at least one measuring tube having an inlet and an outlet and adapted to convey the medium between inlet and outlet;
at least one exciter, which is adapted to excite the at least one measuring tube to execute oscillations;
at least two sensors, which are adapted to register deflections of oscillations of at least one measuring tube;
wherein at least one exciter as well as the sensors each have a coil apparatus with, in each case, at least one coil, as well as, in each case, a magnet apparatus, wherein the magnet apparatuses are movable relative to their coil apparatuses,
wherein the magnet apparatus of a sensor or exciter has, in each case, at least one magnet, wherein the magnet is secured to a measuring tube,
wherein the coils of the sensor or exciter have in a cross section, in each case, a winding region and a central region without windings, and
wherein the magnet apparatus and the coil apparatus of an exciter, or sensor, as the case may be, interact by means of magnetic fields,
wherein the measuring transducer has a support body, which is adapted to hold the at least one measuring tube,
wherein the coil apparatuses of the sensors or the coil apparatus of the exciter is secured separately on the support body,
wherein the support body has at least one first eigenfrequency, and wherein the at least one measuring tube has at least one second eigenfrequency, wherein the exciter is adapted to operate the measuring tube in the region of at least one second eigenfrequency, wherein the at least one first eigenfrequency is pairwise different from the at least one excited second eigenfrequency,
wherein an amplitude peak of the support body in the region of the at least one excited second eigenfrequency of the measuring tube is less by a factor F than an amplitude peak of the at least one measuring tube,
wherein F is at least 1000;
an electronic measuring/operating circuit, wherein the electronic measuring/operating circuit is adapted to operate the sensors and the exciter, and is connected with these by means of electrical connections,
wherein the at least one electrical connection is led by means of a cable guide to the electronic measuring/operating circuit,
wherein the electronic measuring/operating circuit is further adapted to ascertain flow measured values and/or density measured values, and
wherein the measuring device has especially an electronics housing for housing the electronic measuring/operating circuit.
